(19) United States
(12) Patent Application Publication
(10) Pub. No.: US 2003/0168829 A1
(43) Pub. Date: Sep. 11, 2003

(54) Bicycle safety training handle

(76) Inventor: Dana R. Merrill, Norridgewock, ME (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 10/094,313

(22) Filed: Mar. 7, 2002

(51) Int. Cl. B62H 7/00

(52) U.S. Cl. 280/293

(57) ABSTRACT

A bicycle training handle apparatus for a bicycle comprises a tubular frame providing an upwardly directed main tube integral with a pair of spaced apart, downwardly directed, tubular legs. A handle bar is telescopically engaged within the main tube and extends upwardly from it. A pair of leg bars are telescopically engaged with the tubular legs, and adapted for mounting to a bicycle axle. A strut pivotally engages the main tube, and a bicycle seat mounting fixture.

### BACKGROUND OF THE INVENTION

1. Field of the Invention

This invention relates generally to handles and supports for sports equipment and more particularly to a bicycle training handle.

2. Description of Related Art

The following art defines the present state of this field:

Anderberg, U.S. Pat. No. D384,602 describes a bicycle training unit design.

Harrison, U.S. Pat. No. 5,407,222 describes a bicycle guidance device having a handle and at least one extension for positioning the handle above and behind the seat of the bicycle. The extension preferably attaches to the bicycle in the vicinity of the rear axle, and can be pivotally engaged to the axle bolt. A pivotal positioning member is pivotally connected to the bicycle in the vicinity of the seat support, and is operatively and slidably connected to at least one of the extensions to permit the securement of the handle in a desired position. A method for teaching bicycle riding is also disclosed.

May, U.S. Pat. No. 5,487,554 describes a bicycle training device which extends upwardly and rearwardly from the rear of a bicycle to allow an individual to support a rider in an upright position on the bicycle. The training device includes two generally U-shaped members which connect behind the bicycle. A grippable section is thus formed substantially parallel to the ground at an adjustable height.

De Miranda Pinto, U.S. Pat. No. 4,917,398 describes a handle device for bicycles providing an adjustable rider training support point for training helpers. A handle and extension member is pivotally mounted to the rear axle and the pivoting motion conveniently places the handle proximate to the rider, avoiding the extraneous moments and forces experienced by present day fixed handles. The handle is allowed to pivot in the plane of wheel rotation, but the device is fixed in position when the optimum position is achieved. An alternate configuration limits pivoting motion to within a specific range. This allows convenient pushing, pulling and sideways support when the bicycle is at rest or being ridden. The handle is also mounted on telescoping members to conveniently adjust the handle height. The range of motion is also adjustable by a telescoping frame support or a fixture having tapered stops attached to the frame of the bicycle.

Hayes, U.S. Pat. No. 5,683,093 describes a device which is readily mountable to the rear axle and frame of a bicycle and provides a graspable distal end to be held by a person walking or running alongside or just behind a bicycle on which another person is learning how to ride. The device includes three substantially tubular elements connected to each other by a single bolt, washer and nut assembly, and the entire device is mounted in a three-point manner to the bicycle thereby ensuring a strong rigid connection thereto. In one aspect of the invention, the person helping stabilize the rider grasps a suitably textured grip aligned with the plane of the bicycle frame. In another aspect of the invention, one particularly suitable for use by children or when the person learning to ride the bicycle is rather heavy, a pair of grips are mounted transversely of the plane of the bicycle to facilitate a two-handed grasping of the device by the helper.

Fleischer, U.S. Pat. No. 5,791,675 describes a bicycle training device used on a bicycle which provides a user or trainer with the ability to safely and effectively supervise a rider in gaining steering and balance skills. The device is generally U-shaped with a forwardly-disposed handle at the top. The U-shaped handle is connected to the supporting legs by two curved portions. The supporting legs are fixedly attached to the rear of the bicycle at a suitable location such as the rear axle. The device enables the user or trainer to guide the bicycle and rider safely and without exerting undue forces on the bicycle by providing a multiplicity of comfortable and accessible gripping points. These separated gripping portions are available for each hand of the user and the user may guide, push or pull the device from the left side, right side or rear of the bicycle. The device is preferably of unitary tubular construction. It preferably has at least a portion, most preferably, substantially all of its outer surface covered with a cushioning material.

The prior art teaches the use of detachable training handles for bicycles but does not teach such a handle that is adjustable in both height and angle for safety, comfort and convenience of persons of different height and arm strength. The present invention fulfills these needs and provides further related advantages as described in the following summary.

### SUMMARY OF THE INVENTION

The present invention teaches certain benefits in construction and use which give rise to the objectives described below.

A bicycle training handle apparatus for a bicycle comprises a tubular frame providing an upwardly directed main tube integral with a pair of spaced apart, downwardly directed, tubular legs. A handle bar is telescopically engaged within the main tube and extends upwardly from it. A pair of leg bars are telescopically engaged with the tubular legs, and adapted for mounting to a bicycle axle. A strut pivotally engages the main tube, and a bicycle seat mounting fixture.

A primary objective of the present invention is to provide an apparatus and method of use of such apparatus that provides advantages not taught by the prior art.

Another objective is to provide such an invention capable of being easily mounted onto a bicycle.

A further objective is to provide such an invention capable of being easily adjusted for height and angle.

A still further objective is to provide such an invention capable of rigid and reinforced engagement with the bicycle.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a front elevational view of the preferred embodiment of the invention;

FIG. 2 is a right side elevational view thereof.

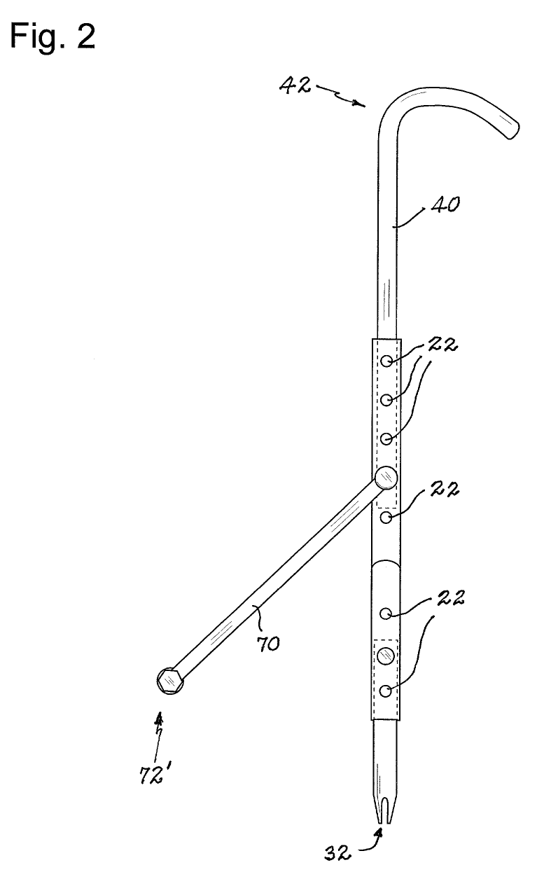

FIG. 3 is a left side elevational view thereof; and

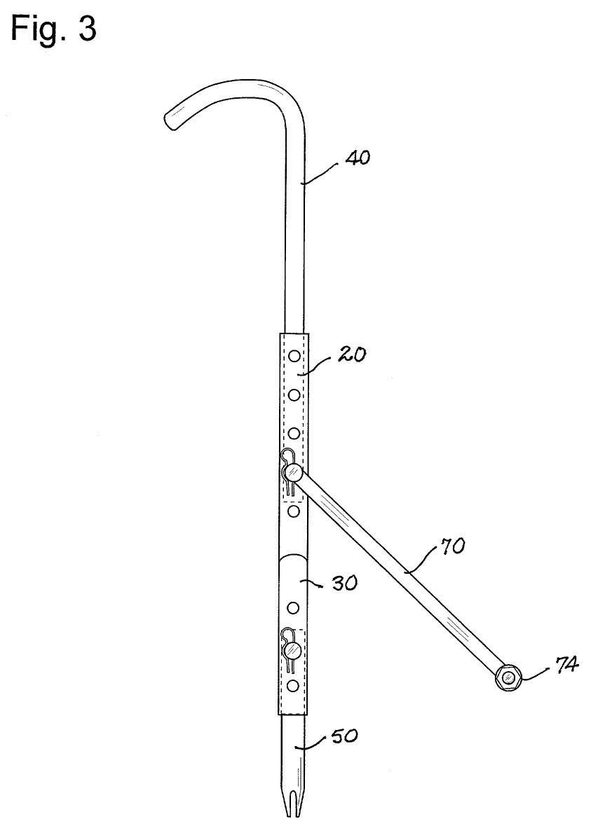

FIG. 4 is similar to FIG. 3 showing the manner in which the invention is attached to a bicycle.

### DETAILED DESCRIPTION OF THE INVENTION

The above described drawing figures illustrate the invention in at least one of its preferred embodiments, which is further defined in detail in the following description.

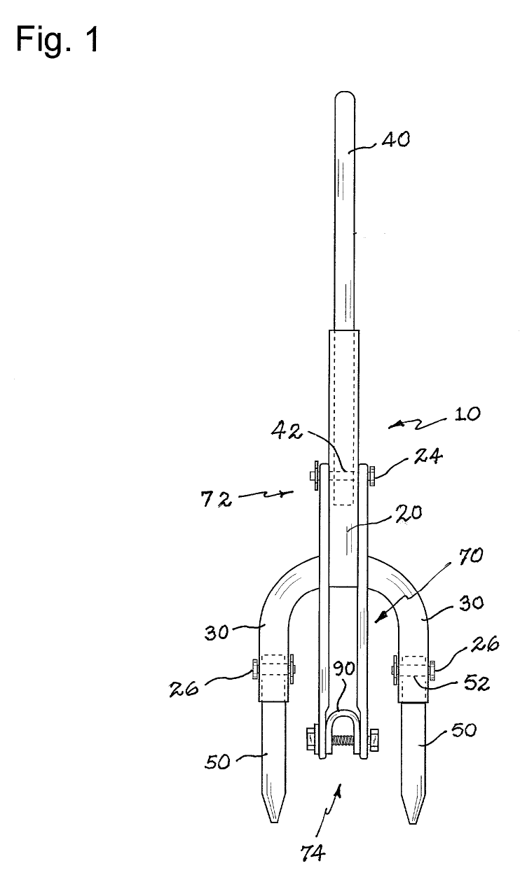

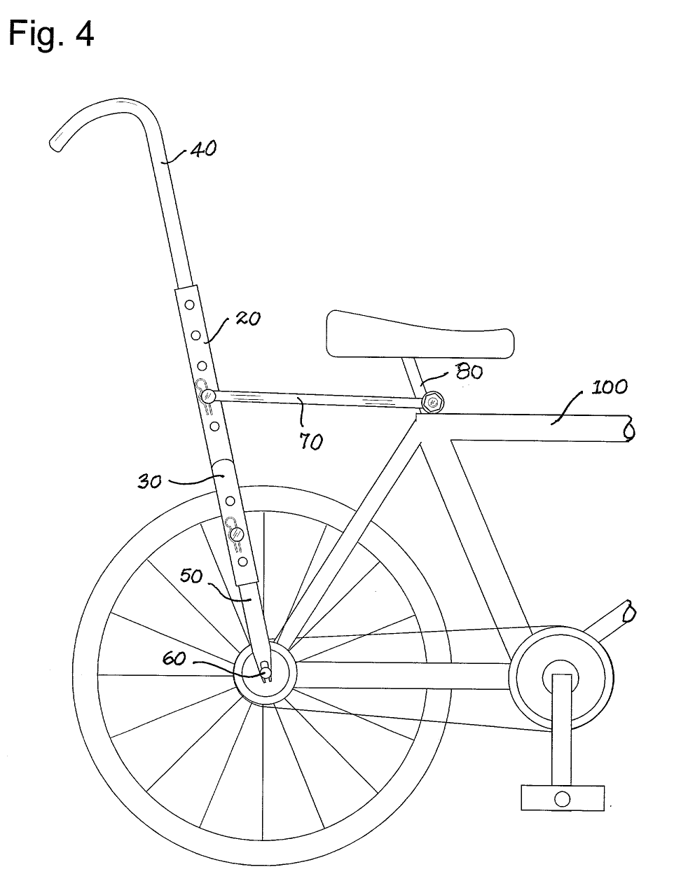

The present invention is a bicycle training handle apparatus for a bicycle. It is constructed of high strength steel or similar rigid and high strength materials. The training handle provides a tubular frame 10 providing an upwardly directed main tube 20 integral with a pair of spaced apart, downwardly directed, tubular legs 30. A handle bar 40 is telescopically engaged within the main tube 20 and adjustably extends upwardly from it. A pair of leg bars 50 are telescopically engaged with the tubular legs 30, and are adapted by terminal slots 32 for mounting to an existing bicycle axle 60, as shown in FIG. 4. A strut 70, which is preferably made of two parallel straps, as shown in FIG. 1, is pivotally engaged at its proximal end 72 with the main tube 20. It is adapted at its distal end 74 for engaging a bicycle seat mounting rod 80.

Preferably, the handle bar 40 is curved rearwardly at its upwardly terminal end 42 so as to provide an improved grip. The main tube 20 provides plural transverse mounting holes 22 arranged in a linear array. Notice that these holes 22 are arranged in pairs positioned on opposing sides of the tube 20. The holes 22 receive a first mounting hardware 24, preferably a joining pin and cotter pin or equivalent securement. This secures the handle bar 40 and the strut 70 at a selected opposing pair of the mounting holes 22. Clearly, the handle bar 40 has a transverse mounting hole 42 as well.

In a similar fashion, the tubular legs 30 each provides plural transverse further mounting holes 22 (again, pairs) arranged, again, in a linear array. These holes 22 receive a second mounting hardware 26, similar to the above, for securing each of the leg bars 50 within a selected one of the mounting holes 22. Clearly, to accomplish this, the leg bars 50 each have one transverse hole 52 as well.

The distal end 72′ of the strut 70 provides a C-shaped yolk 90, preferably made of a bent strap, adapted for encompassing seat mounting rod 80 of the bicycle 100.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A bicycle training handle apparatus for a bicycle, the training handle comprising: a tubular frame providing an upwardly directed main tube integral with a pair of spaced apart, downwardly directed, tubular legs; a handle bar telescopically engaged within the main tube and adjustably extending upwardly therefrom; a pair of leg bars, each one of the leg bars telescopically engaged with one of the tubular legs, and adapted for mounting to a bicycle axle; and, a strut pivotally engaged at a proximal end thereof with the main tube, and adapted at a distal end thereof for engaging a bicycle seat mounting fixture.

2. The apparatus of claim 1 wherein the handle bar is curved rearwardly at an upwardly terminal end thereof.

3. The apparatus of claim 1 wherein the main tube provides plural transverse mounting holes arranged in a linear array, the holes receiving a mounting hardware for securing the handle bar and the strut at a selected one of the mounting holes.

4. The apparatus of claim 1 wherein the tubular legs each provides plural transverse mounting holes arranged in a linear array, the holes receiving a mounting hardware for securing the one of the leg bars at a selected one of the mounting holes.

5. The apparatus of claim 1 wherein the distal end provides a C-shaped yolk adapted for encompassing a frame member of the bicycle.
